(19) United States
(12) Patent Application Publication
(10) Pub. No.: US 2026/0299493 A1
(43) Pub. Date: Oct. 1, 2026

(54) TRANSPORTATION DEVICE AND IMAGE FORMING APPARATUS

(71) Applicant: FUJIFILM Business Innovation Corp., Tokyo (JP)

(72) Inventors: Ryuga OISHI, Kanagawa (JP); Hiroyuki MOMIYAMA, Kanagawa (JP); Toshitaka TANAKA, Kanagawa (JP); Toshio KONDO, Kanagawa (JP)

(73) Assignee: FUJIFILM Business Innovation Corp., Tokyo (JP)

(21) Appl. No.: 19/298,137

(22) Filed: Aug. 12, 2025

(30) Foreign Application Priority Data
Mar. 25, 2025 (JP) 2025-050781

(51) Int. Cl. G03G 15/00

(52) U.S. Cl. CPC G03G 15/6567

(57) ABSTRACT

A transportation device includes a transportation member that transports a medium in a transportation direction, a reciprocating mechanism that reciprocates in the transportation direction and that moves at a speed lower than a transportation speed of the medium transported by the transportation member in a case where the reciprocating mechanism moves to a downstream side, an abutting member that is supported by the reciprocating mechanism and that is switchable between an abutment position at which the medium abuts against the abutting member on a transportation path of the medium and a withdrawal position to which the abutting member withdraws from the transportation path by rotating around an axis after the abutting member passes through a predetermined first position, and a restricting member that restricts the abutting member from rotating to a withdrawal position side until the abutting member passes through the first position.

### CROSS-REFERENCE TO RELATED APPLICATIONS

This application is based on and claims priority under 35 USC 119 from Japanese Patent Application No. 2025-050781 filed Mar. 25, 2025.

### BACKGROUND

### i. Technical Field

The present disclosure relates to a transportation device and an image forming apparatus.

### ii. Related Art

A recording material transportation device described in JP2012-201507A includes a withdrawal member that moves to a downstream side in a transportation direction of a recording material along a transportation path of the recording material at a speed lower than a transportation speed of the recording material transported from an upstream side and that withdraws from the transportation path after a leading end portion of the recording material abuts against the withdrawal member, a first transportation unit that transports the recording material toward the withdrawal member from the upstream side in the transportation direction of the recording material, and a second transportation unit that further transports the recording material abutting against the withdrawal member to the downstream side. The first transportation unit continues to transport the recording material even after the leading end portion of the recording material abuts against the withdrawal member and the recording material is handed over to the second transportation unit without stoppage of transportation of the recording material that is performed by the first transportation unit.

### SUMMARY

Aspects of non-limiting embodiments of the present disclosure relate to a transportation device that makes an abutting member less likely to rotate to a withdrawal position side before the abutting member reaches a predetermined first position in a configuration in which the abutting member switches between an abutment position at which a medium abuts against the abutting member on a transportation path of the medium and a withdrawal position to which the abutting member withdraws from the transportation path by rotating around an axis after the abutting member passes through the first position, in comparison with a configuration in which the abutting member positioned at the abutment position is rotatable around the axis.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a transportation device including a transportation member that transports a medium in a transportation direction, a reciprocating mechanism that reciprocates in the transportation direction and that moves at a speed lower than a transportation speed of the medium transported by the transportation member in a case where the reciprocating mechanism moves to a downstream side, an abutting member that is supported by the reciprocating mechanism and that is switchable between an abutment position at which the medium abuts against the abutting member on a transportation path of the medium and a withdrawal position to which the abutting member withdraws from the transportation path by rotating around an axis after the abutting member passes through a predetermined first position, and a restricting member that restricts the abutting member from rotating to a withdrawal position side until the abutting member passes through the first position.

### BRIEF DESCRIPTION OF THE DRAWINGS

Exemplary embodiment(s) of the present invention will be described in detail based on the following figures, wherein:

FIG. 1 is a front view showing an image forming apparatus according to an exemplary embodiment of the present disclosure;

FIG. 2 is a front view showing of a correction mechanism according to the exemplary embodiment of the present disclosure;

FIGS. 3A and 3B are respectively a plan view and a front view of a major part of a transportation device according to a first exemplary embodiment;

FIGS. 4A and 4B are respectively a plan view and a front view of the major part of the transportation device according to the first exemplary embodiment that is in a state different from a state shown in FIGS. 3A and 3B;

FIGS. 5A and 5B are respectively a plan view and a front view of the major part of the transportation device according to the first exemplary embodiment that is in a state different from a state as shown in FIGS. 3A and 3B and a state as shown in FIGS. 4A and 4B;

FIGS. 6A and 6B are respectively a plan view and a front view of a major part of a transportation device according to a second exemplary embodiment;

FIGS. 7A and 7B are respectively a plan view and a front view of the major part of the transportation device according to the second exemplary embodiment that is in a state different from a state shown in FIGS. 6A and 6B;

FIGS. 8A and 8B are respectively a plan view and a front view of the major part of the transportation device according to the second exemplary embodiment that is in a state different from a state shown in FIGS. 6A and 6B and a state as shown in FIGS. 7A and 7B;

FIGS. 9A and 9B are respectively a plan view and a front view of the major part of the transportation device according to the second exemplary embodiment that is in a state different from states shown in FIGS. 6A to 8B;

FIGS. 10A and 10B are respectively a plan view and a front view of the major part of the transportation device according to the second exemplary embodiment that is in a state different from states shown in FIGS. 6A to 9B;

FIGS. 11A and 11B are respectively a plan view and a front view of a major part of a transportation device according to a third exemplary embodiment; and

FIGS. 12A and 12B are respectively a plan view and a front view of the major part of the transportation device according to the third exemplary embodiment that is in a state different from a state shown in FIGS. 11A and 11B;

### DETAILED DESCRIPTION

Hereinafter, an example of an exemplary embodiment of the technology of the present disclosure will be described with reference to the drawings. The identical reference numerals are given to the identical or equivalent components and parts in each drawing.

Note that an arrow UP represents an upward direction of an image forming apparatus (hereinafter, an apparatus). An arrow DN represents a downward direction of the apparatus, which is a direction opposite to the direction represented by the arrow UP. An arrow RH represents a rightward direction of the apparatus. An arrow LH represents a leftward direction of the apparatus, which is a direction opposite to the direction represented by the arrow RH. An arrow FT represents a frontward direction of the apparatus. An arrow RR represents a rearward direction of the apparatus, which is a direction opposite to the direction represented by the arrow FT. The arrow UP and the arrow DN, the arrow RH and the arrow LH, and the arrow FT and the arrow RR are orthogonal to each other.

In addition, an arrow FW represents a forward movement direction of a movement direction of a reciprocating mechanism of the image forming apparatus. An arrow BW represents a backward movement direction, which is a direction opposite to the direction represented by the arrow FW. The arrow FW and the arrow BW may not coincide with the arrow RH and the arrow LH.

### Overall Configuration of Image Forming Apparatus

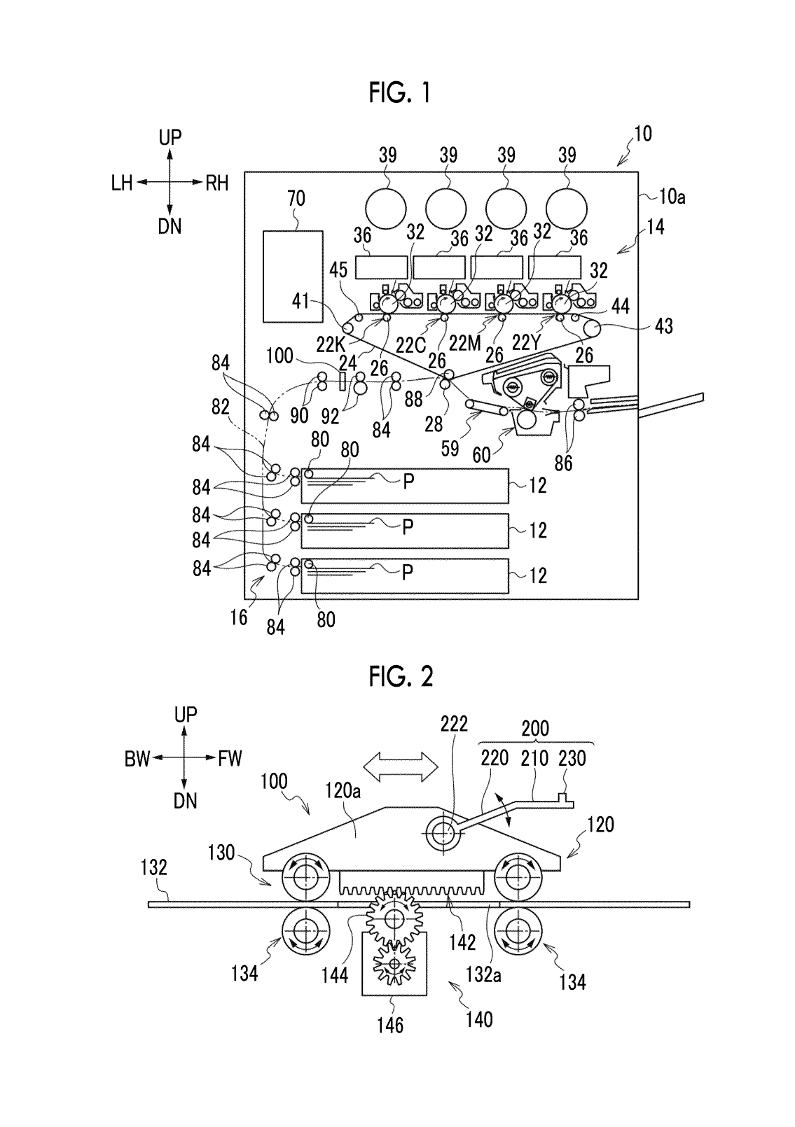

An image forming apparatus 10 forms an image on a recording medium P. The recording medium P is an example of a medium. As shown in FIG. 1, the image forming apparatus 10 includes a housing 10a in which each component is accommodated. In the housing 10a, accommodation portions 12, an image forming unit 14, a transportation unit 16, a fixing device 60, and a controller 70 are provided. The housing 10a is an example of an apparatus body.

### Accommodation Portions

A plurality of accommodation portions 12 are disposed in a lower portion of the image forming apparatus 10 and accommodate the sheet-shaped recording mediums P. In the present exemplary embodiment, three accommodation portions 12 are disposed in the lower portion of the image forming apparatus 10.

### Image Forming Unit

The image forming unit 14 forms an image on the recording medium P. The image forming unit 14 is an example of a forming unit. The image forming unit 14 includes image formation units 22Y, 22M, 22C, and 22K (hereinafter, “22Y to 22K”), an intermediate transfer belt 24, a primary transfer roll 26, and a secondary transfer roll 28.

The image formation units 22Y to 22K form yellow (Y), magenta (M), cyan (C), and black (K) toner images, respectively.

Note that in the following description, in a case where yellow, magenta, cyan, and black are not to be particularly distinguished from each other, Y, M, C, and K at ends of reference numerals will be omitted.

The image formation units 22 of the respective colors are disposed above the intermediate transfer belt 24 and are arranged in a width direction. Each of the image formation units 22 performs a step of charging a photoreceptor 32, an exposure step, a development step, and a step of performing transfer to the intermediate transfer belt 24 which will be described later.

The toner images formed by the image formation units 22Y to 22K are transferred to the intermediate transfer belt 24. The intermediate transfer belt 24 is formed in a triangular shape such that a vertex thereof is on a lower side. Winding rolls 41, 43, 44, 45, and 88 around which the intermediate transfer belt 24 is wound are provided on an inner peripheral side of the intermediate transfer belt 24. For example, the intermediate transfer belt 24 circulates (rotates) in one direction (for example, a counterclockwise direction in FIG. 1) in a state of being in contact with the photoreceptors 32 by being rotationally driven by the winding roll 43.

The primary transfer rolls 26 transfer the toner images formed by the image formation units 22 to the intermediate transfer belt 24. The primary transfer rolls 26 of the respective colors face the photoreceptors 32 with the intermediate transfer belt 24 interposed therebetween.

The secondary transfer roll 28 transfers the toner images, which are transferred to the intermediate transfer belt 24 by the primary transfer rolls 26, to the recording medium P from the intermediate transfer belt 24. The secondary transfer roll 28 faces the winding roll 88 with the intermediate transfer belt 24 interposed therebetween. A position between the secondary transfer roll 28 and the winding roll 88 is a second transfer position where the toner images transferred onto the intermediate transfer belt 24 are transferred onto the recording medium P.

### Transportation Unit

The transportation unit 16 transports the recording medium P from the accommodation portions 12 to the image forming unit 14. The transportation unit 16 includes feeding rolls 80, transportation rolls 84, a correction mechanism 100, and a belt transportation unit 59.

A plurality of the feeding rolls 80 are disposed and each feeding roll 80 feeds the recording medium P accommodated in each accommodation portions 12 along a transportation path 82. The transportation path 82 is an example of a transportation path.

The transportation rolls 84 transport the recording medium P fed by the feeding roll 80 to the second transfer position. A plurality of pairs of the transportation rolls 84 are disposed along the transportation path 82. The transportation rolls 84 include first transportation rolls 90 and second transportation rolls 92.

The first transportation rolls 90 transport the recording medium P in a transportation direction at a predetermined first speed. The first speed is an example of a transportation speed. The second transportation rolls 92 are disposed downstream of the first transportation rolls 90 in the transportation direction and receive the recording medium P from gates 200 which will be described later. For example, the diameter of one of the second transportation rolls 92 that is disposed on a lower side in the transportation path 82 is larger than the diameter of the other of the second transportation rolls 92 that is disposed on an upper side in the transportation path 82. The first transportation rolls 90 are an example of a transportation member.

The correction mechanism 100 is disposed between the first transportation rolls 90 and the second transportation rolls 92. Details of the correction mechanism 100 will be described later.

The belt transportation unit 59 transports the recording medium P, to which the toner images are transferred by the secondary transfer roll 28, to a downstream side with respect to the second transfer position in the transportation direction of the recording medium P.

### Fixing Device

The fixing device 60 is disposed downstream of the belt transportation unit 59 in the transportation direction. The fixing device 60 fixes, onto the recording medium P, the toner images transferred to the recording medium P. The fixing device 60 is provided with discharge rolls 86. The discharge rolls 86 discharge, from the housing 10a, the recording medium P onto which the toner images are fixed.

### Controller

The controller 70 is disposed in the housing 10a and controls each component of the image forming apparatus 10.

### Image Forming Operation

Next, an image forming operation of forming an image on the recording medium P in the image forming apparatus 10 according to the present exemplary embodiment will be described.

In the image forming apparatus 10, the recording medium P fed from the accommodation portion 12 by the feeding roll 80 is fed to the second transfer position by a plurality of the transportation rolls 84.

Meanwhile, in the image formation units 22 of the respective colors, toner images are formed on the photoreceptors 32 through the charging of the photoreceptors 32, exposure, and development.

Color toner images respectively formed by the image formation units 22 are superimposed on the intermediate transfer belt 24 at a first transfer position by the primary transfer rolls 26 of the respective colors, so that a color image is formed. Then, the color image formed on the intermediate transfer belt 24 is transferred onto the recording medium P by the secondary transfer roll 28.

The recording medium P onto which the toner images are transferred is transported to the fixing device 60 by the belt transportation unit 59, and the transferred toner images are fixed by the fixing device 60. The recording medium P onto which the toner images are fixed is discharged from the housing 10a by the discharge rolls 86.

### Configuration of Correction Mechanism

Next, the correction mechanism 100 will be described. The correction mechanism 100 corrects inclination of the recording medium P with respect to the transportation direction by causing a leading end of the recording medium P to abut against the gates 200 which will be described later. The correction mechanism 100 transports the recording medium P in the transportation direction at a second speed lower than the first speed. The correction mechanism 100 constitutes a transportation device together with the first transportation rolls 90. As shown in FIG. 2, the correction mechanism 100 includes a carriage 120 and the gates 200.

### Carriage

The carriage 120 is able to reciprocate in the transportation direction between the first transportation rolls 90 and the second transportation rolls 92. The carriage 120 is an example of a reciprocating mechanism. The carriage 120 moves at the second speed in the forward movement direction. In addition, movement in the forward movement direction is an example of movement toward a downstream side. The carriage 120 is provided with a guide mechanism 130 and a driving mechanism 140 with respect to a body 120a.

The guide mechanism 130 guides the body 120a such that the carriage 120 moves along the transportation direction. The guide mechanism 130 includes a support plate 132 and pairs of roll members 134.

The support plate 132 is a plate-shaped body that is supported by the housing 10a and that extends in the transportation direction. In the present exemplary embodiment, the support plate 132 extends in the transportation direction in an area in which the carriage 120 reciprocates. The support plate 132 supports the body 120a from below. A long hole 132a is formed in the support plate 132. The long hole 132a is a hole formed along the transportation direction.

The pairs of roll members 134 are supported to be rotatable with respect to the body 120a. One of paired roll members 134 is in contact with an upper surface of the support plate 132. In addition, the other of the paired roll members 134 is in contact with a lower surface of the support plate 132. Accordingly, the pairs of roll members 134 guide the carriage 120 that reciprocates. In the present exemplary embodiment, two pairs of roll members 134 are provided on an upstream side and a downstream side in a movement direction of the carriage 120.

The driving mechanism 140 is provided below the body 120a. The driving mechanism 140 reciprocates the body 120a in the transportation direction. The driving mechanism 140 includes a rack 142, a pinion 144, and a motor 146.

The rack 142 extends in the transportation direction. The rack 142 is supported by the body 120a in a state of facing a lower side.

The pinion 144 is supported to be rotatable with respect to the housing 10a. The pinion 144 is disposed below the rack 142 in a state where a part of the pinion 144 protrudes through the long hole 132a. The pinion 144 meshes with the rack 142.

The motor 146 is supported by the housing 10a. The motor 146 rotates the pinion 144 by means of an output gear. The motor 146 can be rotated forward and backward. In the present exemplary embodiment, the motor 146 drives the output gear so that the pinion 144 and the rack 142 are driven.

In a case where a sensor (not shown) that is disposed at a predetermined position on the transportation path 82 (for example, a position upstream of the first transportation rolls 90) detects a leading end of the recording medium P while the recording medium P is being transported, the motor 146 drives the output gear such that the body 120a moves at the second speed in the forward movement direction without a change in speed. In addition, in a case where a sensor (not shown) that is disposed upstream of the second transportation rolls 92 detects the leading end of the recording medium P while the recording medium P is being transported, the motor 146 drives the pinion 144 such that the body 120a moves at a predetermined speed in the backward movement direction (for example, at 75% of the first speed).

Accordingly, the carriage 120 reciprocates in the transportation direction.

### Gate

The gates 200 are formed as plate-shaped bodies on which the recording medium P can be placed. The gates 200 are supported with respect to the carriage 120 to be swingable around a central axis of a shaft 222. Swinging is an example of rotation. The gates 200 can switch between an abutment position where the leading end of the recording medium P abuts against the gates 200 on the transportation path 82 and a withdrawal position to which the gates 200 are rotated with respect to the carriage 120 and withdraw from the transportation path 82 after passing through a predetermined position on the transportation path 82. The gates 200 correct inclination of the recording medium P with respect to the transportation direction at the abutment position. The gates 200 are an example of an abutting member.

In the present exemplary embodiment, a plurality of the gates 200 are disposed in a state of being separated from each other in a front-rear direction. In addition, in the present exemplary embodiment, the gates 200 can protrude or withdraw through an opening of a plate (not shown), which is supported by the housing 10a along the transportation path 82, by means of a major portion which will be described later. At the abutment position, the gates 200 partially protrude through the opening. Meanwhile, at the withdrawal position, the gates 200 are positioned below the plate. That is, the gates 200 withdrawn from the transportation path 82 may also mean the gates 200 being positioned below the plate.

Each of the gates 200 includes a base portion 210, a connection portion 220, and a protruding piece 230.

The base portion 210 is a plate-shaped portion extending in one direction. The base portion 210 guides, to the protruding piece 230, the recording medium P placed from above.

The connection portion 220 is a plate-shaped portion that extends obliquely toward the shaft 222 from the base portion 210 and connects the base portion 210 to the body 120a of the carriage 120 to be rotatable. Specifically, one end of the connection portion 220 is integrally connected to the shaft 222. The central axis of the shaft 222 is an example of an axis. In addition, the other end of the connection portion 220 is connected to the base portion 210.

The protruding piece 230 is a wall-shaped portion that extends in the front-rear direction and that is erected on the base portion 210. The protruding piece 230 has a first surface facing the upstream side in the transportation direction. The first surface of the protruding piece 230 comes into contact with a leading end of the recording medium P at the abutment position. The protruding piece 230 is disposed at a position offset from an end portion of the base portion 210 that is on the downstream side in the transportation direction, the protruding piece 230 being positioned upstream of the end portion.

As described above, each gate 200 is configured.

### Correction Performed by Correction Mechanism

Next, inclination correction of the recording medium P with respect to the transportation direction, which is performed by the correction mechanism 100, will be described.

In the correction mechanism 100, in a case where a sensor (not shown) detects that the recording medium P is being transported by the first transportation rolls 90, the motor 146 is driven so that the carriage 120 starts to move at the second speed in the forward movement direction of the recording medium P. As the carriage 120 moves at the second speed, the gate 200 also moves at the second speed in the forward movement direction. A leading end of the recording medium P transported at the first speed abuts against the gates 200 that move at the second speed without a change in speed and that are at the abutment position. The recording medium P is continuously transported with the leading end abutting against the gates 200. Accordingly, the leading end of the recording medium P is aligned along the front-rear direction, and inclination of the recording medium P with respect to the transportation direction is corrected. The recording medium P, of which the inclination with respect to the transportation direction is corrected, is delivered to the second transportation rolls 92.

Meanwhile, in the correction mechanism 100, in a case where a sensor (not shown) detects that the recording medium P is being transported by the second transportation rolls 92, the motor 146 is driven so that the carriage 120 starts to move in the backward movement direction of the recording medium P. While the carriage 120 is moving in the backward movement direction, the gates 200 switch from the withdrawal position to the abutment position. Then, the gates 200 wait for transportation of another recording medium P.

### Major Part of First Exemplary Embodiment

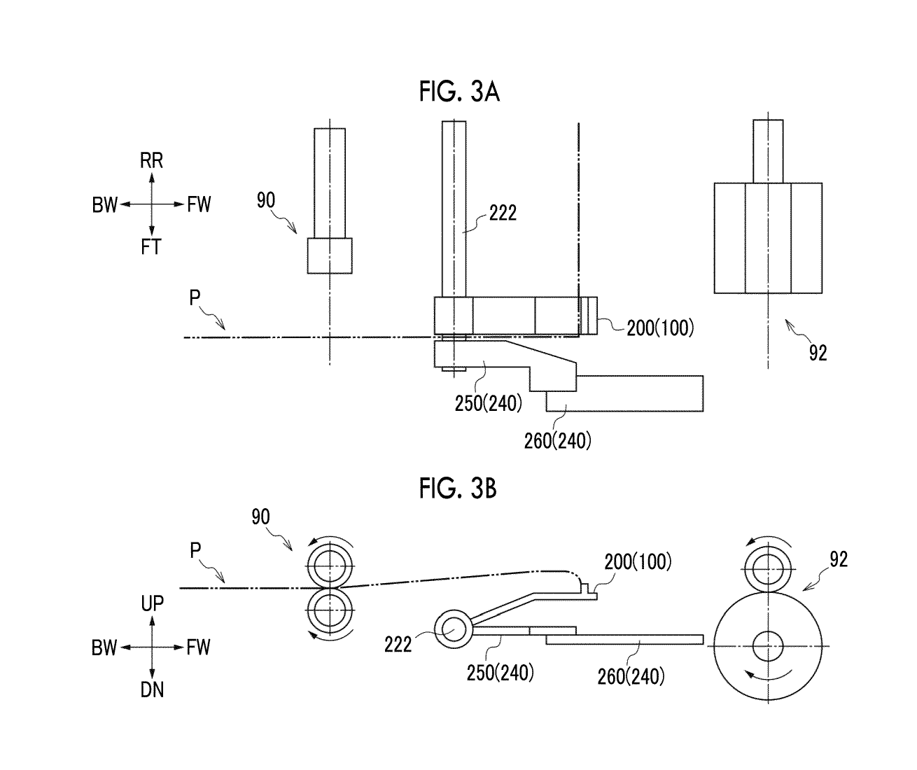

Next, a major part of a first exemplary embodiment will be described with reference to FIGS. 3A to 5B. Note that in the following description, the first transportation rolls 90, the second transportation rolls 92, the gates 200 of the correction mechanism 100, and operations related to the first transportation rolls 90, the second transportation rolls 92, and the gates 200 will be described, the first transportation rolls 90, the second transportation rolls 92, and the gates 200 constituting the transportation device. In addition, in the first exemplary embodiment, the gates 200 are urged to a withdrawal position side from an abutment position side by an urging member (not shown).

As shown in FIGS. 3A and 3B, the correction mechanism 100 includes a first fall prevention member 240 that prevents the gates 200 from being rotated to the withdrawal position side by the transported recording medium P until the gates 200 pass through a predetermined position. The first fall prevention member 240 is an example of a restricting member. The first fall prevention member 240 includes a first member 250 and a second member 260.

The first member 250 is formed in a thin plate-like shape and is supported at an end portion on the upstream side in the transportation direction to be non-rotatable with respect to the shaft 222. The first member 250 integrally rotates with the gates 200. In the present exemplary embodiment, the gates 200 are provided with the first member 250 via the shaft 222. The first member 250 comes into contact with the second member 260, which will be described later, so that the gates 200 are held at the abutment position. The first member 250 is an example of a holding target portion.

In addition, the first member 250 is disposed outside a sheet passage area as seen in a plan view. The sheet passage area is an area in which the recording medium P having the maximum size that can be processed by the image forming apparatus 10 passes through the transportation path 82. Specifically, as seen in the plan view, the first member 250 is disposed ahead of the gates 200 with respect to the shaft 222. In addition, as seen in a front view, the first member 250 is supported by the shaft 222 at the abutment position in a state of being disposed below the base portions 210 of the gates 200. In addition, the first member 250 is formed such that an end portion on the downstream side in the transportation direction protrudes to be closer to the front side than an end portion on the upstream side is. At the abutment position, the end portion of the first member 250 that is on the downstream side in the transportation direction is disposed upstream of end portions of the gates 200 that are on the downstream side in the transportation direction.

The second member 260 is a thin plate extending in the transportation direction. The second member 260 is supported by the housing 10a. The second member 260 is an example of a supporting portion. An end portion of the second member 260 that is on the downstream side in the transportation direction is disposed upstream of the second transportation rolls 92 in the transportation direction. At the abutment position, the second member 260 functions as a rotation stopper of the gates 200 by supporting, from below, the end portion of the first member 250 that is on the downstream side in the transportation direction. That is, at the abutment position, the second member 260 restricts the gates 200 from rotating to the withdrawal position side. At the withdrawal position, the second member 260 is disposed in the housing 10a so as not to be in contact with the first member 250. In other words, regarding the first member 250 and the second member 260, the respective lengths thereof in the transportation direction and disposition with respect to the housing 10a are set in accordance with abutment and withdrawal of the gates 200.

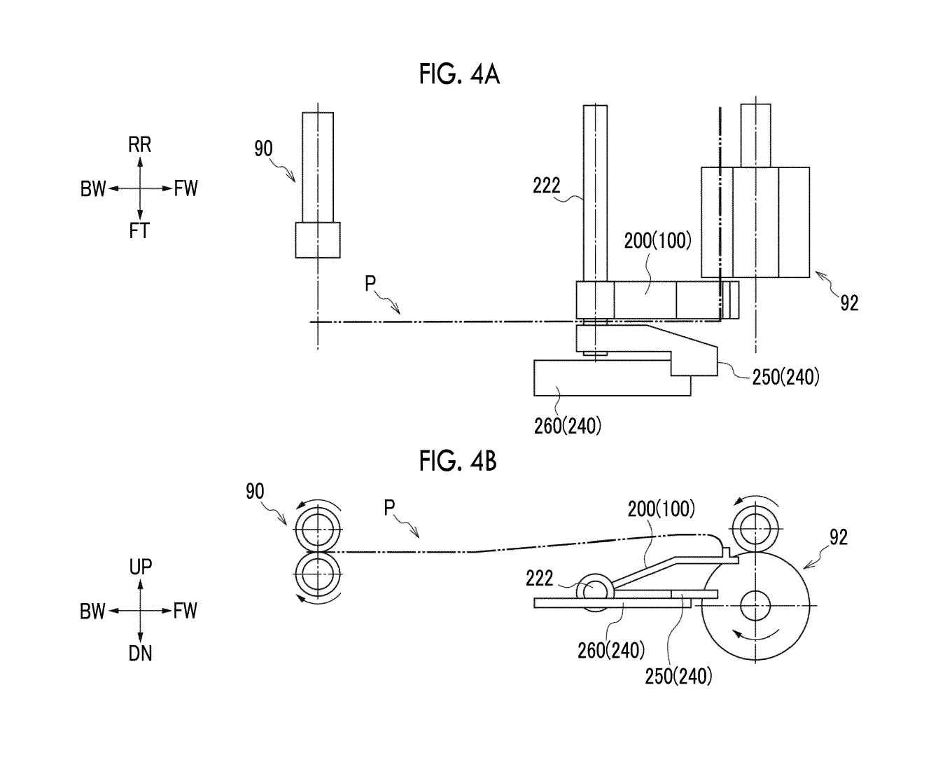

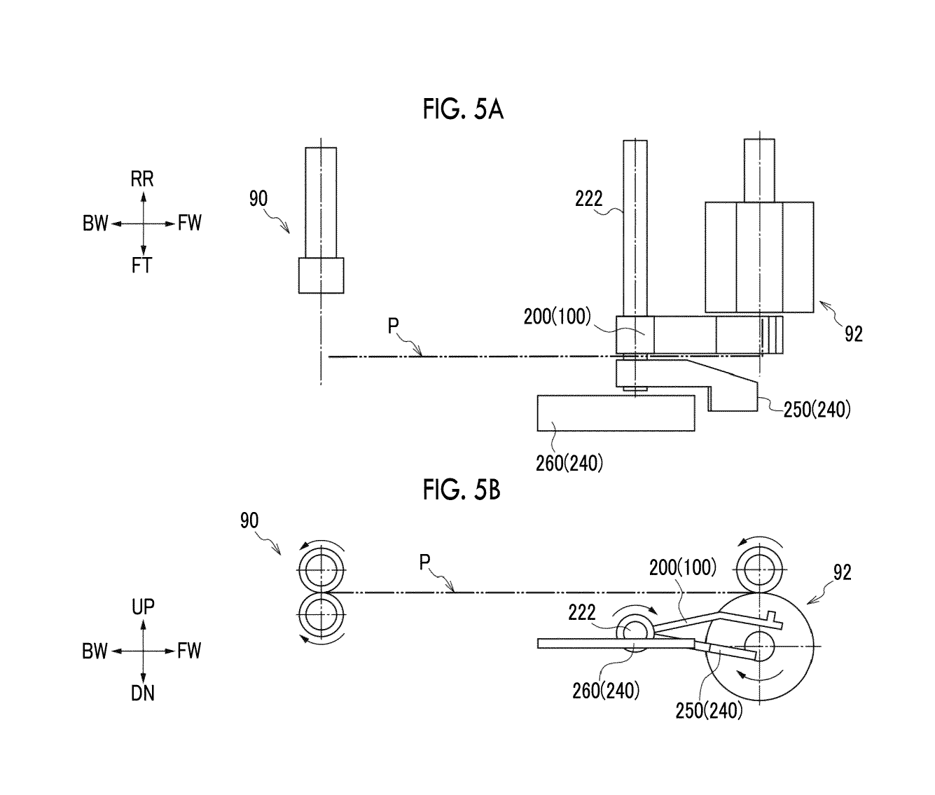

As shown in FIGS. 4A and 4B, at the abutment position after movement of the gates 200 in the forward movement direction, the first member 250 is supported by the second member 260. In a case where the gates 200 are further moved in the forward movement direction, the first member 250 approaches the end portion of the second member 260 that is on the downstream side in the transportation direction. In a case where the end portion passes through the first member 250, as shown in FIGS. 5A and 5B, the first member 250 stops being supported by the second member 260 and a switch from the abutment position to the withdrawal position occurs. A position at which the first member 250 passes through the end portion of the second member 260 that is on the downstream side in the transportation direction is an example of a first position.

Accordingly, regarding the first fall prevention member 240, the first member 250 is in contact with the second member 260 so that the gates 200 are held at the abutment position until the gates 200 pass through the predetermined position.

### Action and Effect of First Exemplary Embodiment

The action and effect of the first exemplary embodiment will be described.

The transportation device including the first transportation rolls 90 and the correction mechanism 100 according to the present exemplary embodiment includes the first transportation rolls 90 that transport the recording medium P in the transportation direction, the carriage 120 that reciprocates in the transportation direction and that moves at the second speed lower than the first speed, which is the transportation speed of the recording medium P transported by the first transportation rolls 90, in a case where the carriage 120 moves in the forward movement direction, the gates 200 that are supported by the carriage 120 and that are switchable between the abutment position at which the recording medium P abuts against the gates 200 on the transportation path 82 of the recording medium P and the withdrawal position to which the gates 200 withdraw from the transportation path 82 by rotating around the central axis of the shaft 222 after the gates 200 pass through a predetermined position, and the first fall prevention member 240 that restricts the gates 200 from rotating to a withdrawal position side until the gates 200 pass through the predetermined position.

According to such a configuration, the gates 200 are less likely to rotate to the withdrawal position side before the gates 200 reach the predetermined position in a configuration in which the gates 200 switch between the abutment position at which the recording medium P abuts against the gates 200 on the transportation path 82 of the recording medium P and the withdrawal position to which the gates 200 withdraw from the transportation path 82 by rotating around the central axis of the shaft 222 after the gates 200 pass through the predetermined position, in comparison with a configuration in which the gates 200 positioned at the abutment position are rotatable around the central axis of the shaft 222.

In addition, in the transportation device according to the present exemplary embodiment, the gates 200 are urged toward the abutment position or the withdrawal position and the first fall prevention member 240 holds the gates 200 at the abutment position until the gates 200 pass through the predetermined position.

According to such a configuration, rotation of the gates 200 is suppressed in comparison with a configuration in which the gates 200 are rotatable to a side opposite to a side to which the gates 200 are restricted from rotating by the first fall prevention member 240.

In addition, in the transportation device according to the present exemplary embodiment, the gates 200 are urged toward the withdrawal position, and the first fall prevention member 240 includes the second member 260 that extends in the transportation direction and that is supported by the housing 10a and the first member 250 that is supported by the shaft 222 supporting the gates 200 and that is in contact with the second member 260 so that the gates 200 are held at the abutment position until the gates 200 pass through the predetermined position.

According to such configuration, the first fall prevention member 240 may be simplified in comparison with a configuration in which rotation to the withdrawal position side is restricted by means of electric power.

In addition, in the transportation device according to the present exemplary embodiment, the first member 250 is formed in a plate-like shape extending in the transportation direction.

According to the configuration, movement of the first member 250 is stabilized in comparison with a configuration in which the first member 250 has a rod-like shape that extends in a direction intersecting the transportation direction.

In addition, the image forming apparatus according to the present exemplary embodiment includes the transportation device including the first transportation rolls 90 and the correction mechanism 100 and the image forming unit 14 that forms an image on the recording medium P transported by the transportation device.

According to the configuration, an image forming apparatus may be provided in which an abutting member is less likely to rotate to a withdrawal position side in comparison with a configuration in which the abutting member rotates to the withdrawal position side before the abutting member passes through a first position.

### Second Exemplary Embodiment

Next, a second exemplary embodiment will be described. In the second exemplary embodiment, the configuration of the correction mechanism 100 is different with respect to the major part of the first exemplary embodiment.

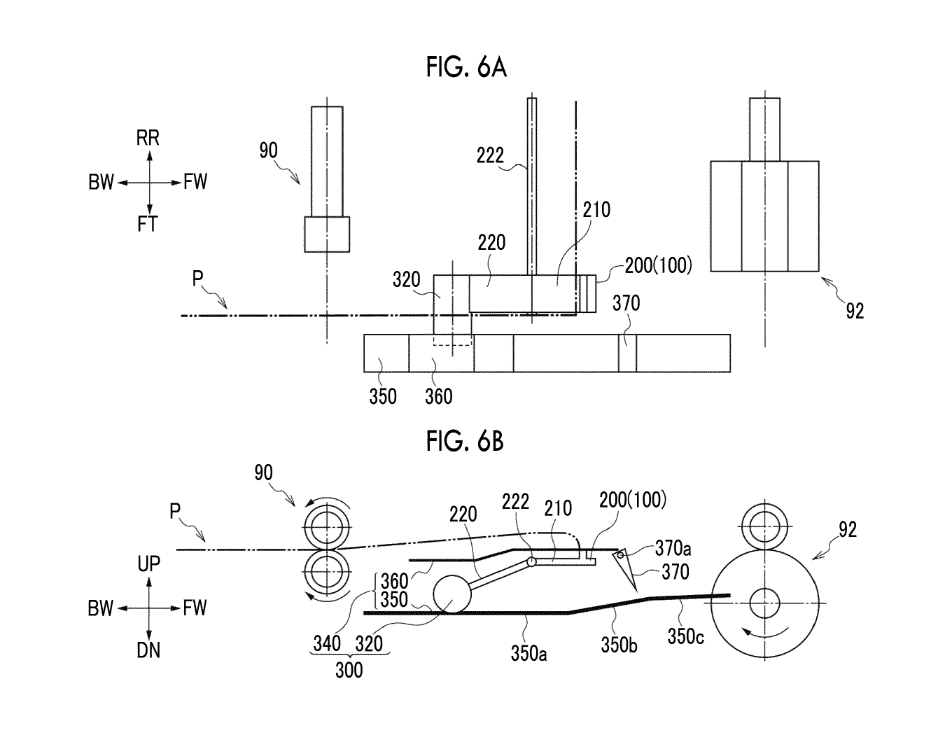

In the second exemplary embodiment, as shown in FIGS. 6A and 6B, the correction mechanism 100 includes a second fall prevention member 300 that prevents the gates 200 from being caused to fall by the transported recording medium P until the gates 200 pass through a predetermined position. The second fall prevention member 300 is an example of a restricting member. In addition, in the second exemplary embodiment, the gates 200 are urged toward the abutment position by an urging member (not shown). For example, one end of the urging member is supported by the housing 10a and the other end of the urging member urges the gates 200 to the abutment position. In addition, in the second exemplary embodiment, the gates 200 are rotatable around the central axis of the shaft 222 disposed at a connection portion between the base portions 210 and the connection portions 220. The second fall prevention member 300 includes a weight 320 and a guide mechanism 340.

The weight 320 is formed in a columnar shape extending along the shaft 222. The weight 320 is provided at an end portion of the connection portion 220 on a side opposite to an end portion of the connection portion 220 that is on a side on which the shaft 222 is disposed. The weight 320 urges the gates 200 to the abutment position with the central axis of the shaft 222 as a rotation center. In addition, a front end portion of the weight 320 is disposed outside the sheet passage area. The front end portion of the weight 320 according to the present exemplary embodiment is disposed closer to the front side than front end portions of the gates 200 are. The weight 320 reciprocates in the transportation direction as the gates 200 and the shaft 222 reciprocate in the transportation direction.

The guide mechanism 340 guides the weight 320 reciprocating in the transportation direction. The guide mechanism 340 is an example of a guide portion. The guide mechanism 340 is supported by the housing 10a. The guide mechanism 340 includes a first guide 350, a second guide 360, and a switch 370.

The first guide 350 is a plate-shaped body extending in the transportation direction. The first guide 350 guides, from below, the weight 320 that is in a state of being urged due to the weight of the weight 320 in a case where the weight 320 moves in the forward movement direction. The first guide 350 is an example of a forward path portion. The first guide 350 includes a first section portion 350a, a second section portion 350b, and a third section portion 350c.

The first section portion 350a extends in the transportation direction and is a section in which the gates 200 are positioned at the abutment position. In the first section portion 350a, the gates 200 are movable in the forward movement direction in a state of being held at the abutment position.

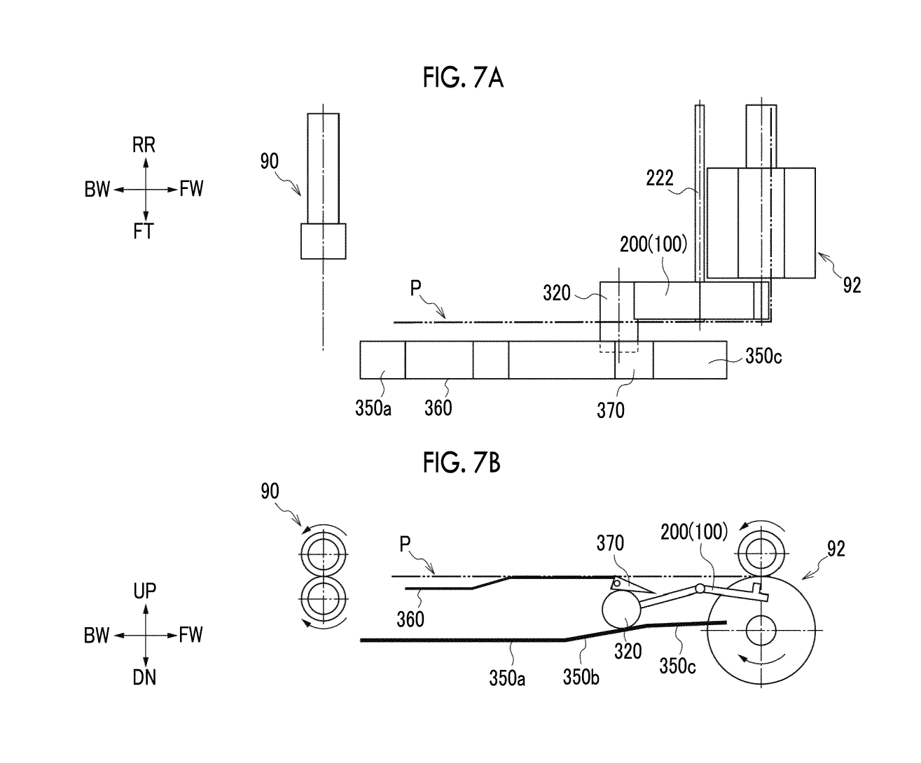

As shown in FIGS. 7A and 7B, the second section portion 350b is a section in which the forward movement direction is inclined upward with respect to the first section portion 350a. The second section portion 350b is a section in which the gates 200 switch from the abutment position to the withdrawal position side with the weight 320 displaced. A connection portion between the second section portion 350b and the first section portion 350a is an example of the first position.

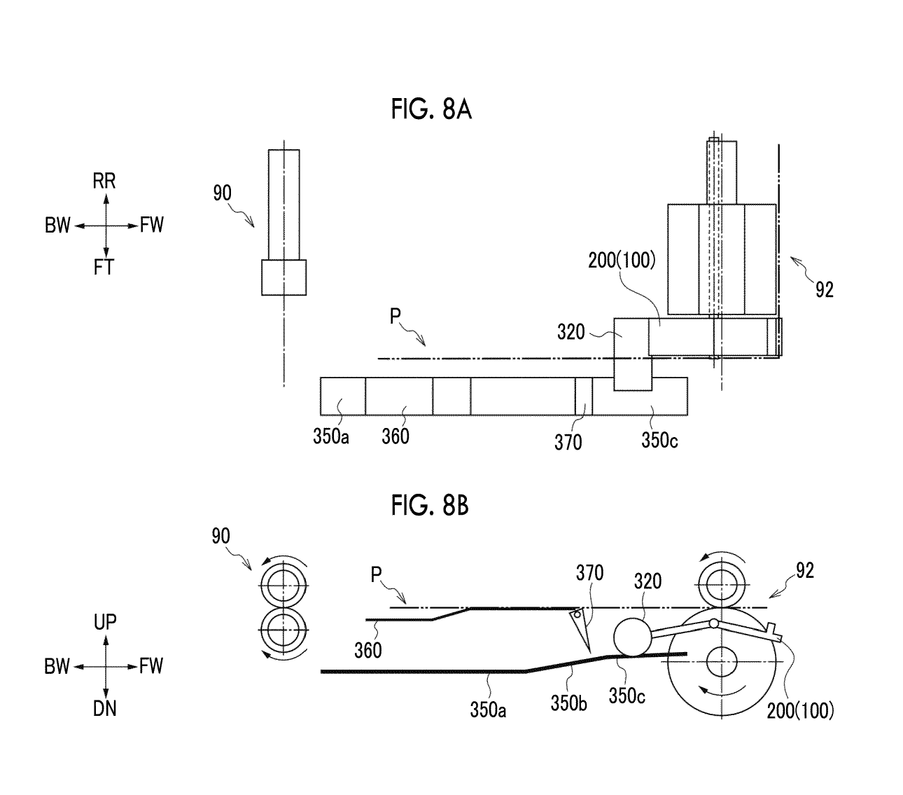

As shown in FIGS. 8A and 8B, the third section portion 350c is a section in which the forward movement direction is inclined upward with respect to the first section portion 350a and the degree of upward inclination of the forward movement direction is lower than the degree of upward inclination in the second section portion 350b. The third section portion 350c is a section in which the gates 200 are positioned close to the withdrawal position side in comparison with a posture in which the gates 200 at the second section portion 350b are.

As shown in FIGS. 6A and 6B, the second guide 360 is a plate-shaped body extending in the transportation direction. The second guide 360 is disposed above the first guide 350. The second guide 360 is configured such that the weight 320 can pass through a space between the first guide 350 and the second guide 360. The second guide 360 guides the weight 320 from below in a case where the weight 320 moves in the backward movement direction. The second guide 360 is an example of a backward path portion.

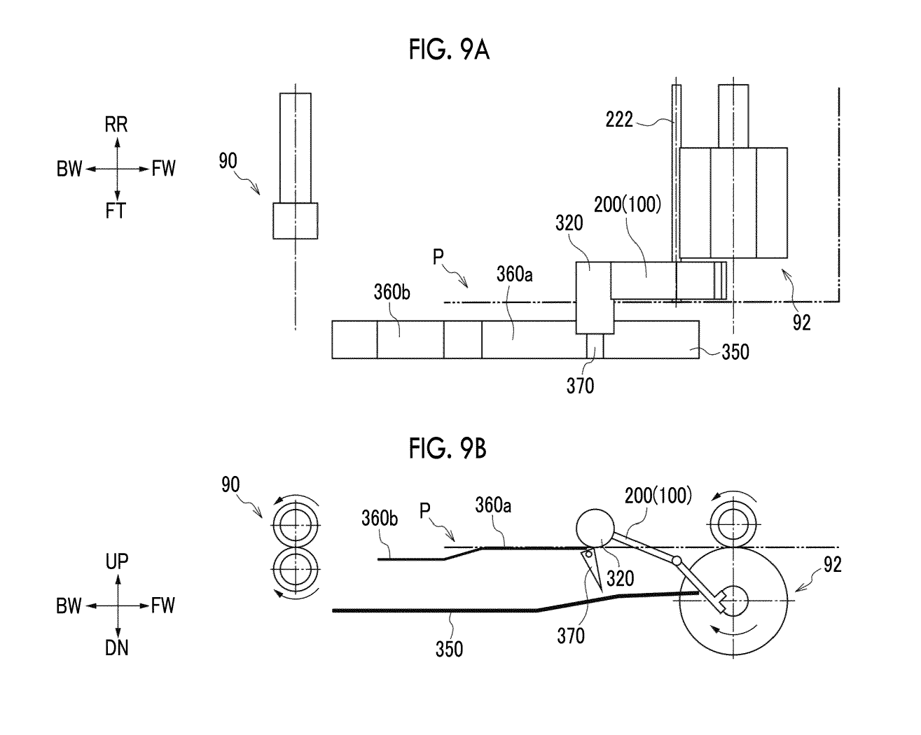

In addition, an end portion of the second guide 360 that is on the upstream side in the transportation direction is disposed downstream of an end portion of the first guide 350 that is on the upstream side in the transportation direction. An end portion of the second guide 360 that is on the downstream side in the transportation direction is disposed upstream of an end portion of the first guide 350 that is on the downstream side in the transportation direction. Therefore, the second guide 360 is formed to be shorter than the first guide 350 in the transportation direction. As shown in FIGS. 9A and 9B, the second guide 360 includes at least a first section portion 360a and a second section portion 360b.

The first section portion 360a extends in the transportation direction and is a section in which the gates 200 are positioned at the withdrawal position. In the first section portion 360a, the gates 200 are movable in the backward movement direction in a state of being held at the withdrawal position.

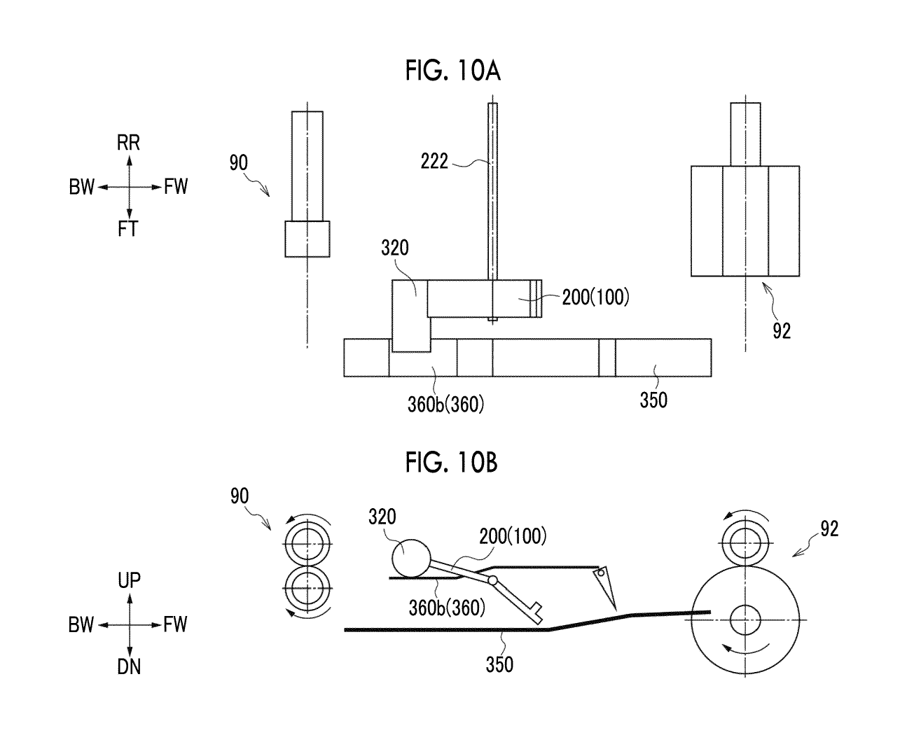

The second section portion 360b is a section that is disposed below the first section portion 360a and upstream of the first section portion 360a in the transportation direction and that is formed to continue from the first section portion 360a. An end portion of the second section portion 360b that is on the upstream side in the transportation direction is the end portion of the second guide 360 that is on the upstream side in the transportation direction. As shown in FIGS. 10A and 10B, at the second section portion 360b, the weight 320 is close to the first guide 350 side in comparison with the position of the weight 320 at the first section portion 360a.

In a case where the weight 320 moves on the second section portion 360b in the backward movement direction and then the weight 320 passes through the end portion of the second section portion 360b that is on the upstream side in the transportation direction in the backward movement direction, the weight 320 moves to the first guide 350 due to the weight of the weight 320 and an urging force of the urging member (not shown).

As shown in FIGS. 6A and 6B, the switch 370 is disposed between the first guide 350 and the second guide 360. The switch 370 is supported to be rotatable around a shaft 370a with respect to the housing 10a at one end. The switch 370 is urged by a compression coil spring (not shown) from the upstream side in the transportation direction at the other end. The switch 370 switches between the first guide 350 or the second guide 360 on which the weight 320 moves. The switch 370 is an example of a switching unit.

As shown in FIGS. 7A and 7B, the other end of the switch 370 is pressed upward by the weight 320 in a case where the weight 320 passes through the second section portion 350b of the first guide 350. In addition, as shown in FIGS. 8A and 8B, the other end of the switch 370 that is pressed upward by the weight 320 returns to the original position in a case where the weight 320 is positioned on the third section portion 350c of the first guide 350. In addition, regarding the switch 370, in a case where the weight 320 is to be displaced from the first guide 350 to the second guide 360, the weight 320 enters a state as shown in FIGS. 9A and 9B by passing though a position on the switch 370 that is in a state of being urged by the compression coil spring.

As described above, the second fall prevention member 300 is configured.

### Action and Effect of Second Exemplary Embodiment

The action and effect of the second exemplary embodiment will be described.

In the transportation device according to the present exemplary embodiment, the gates 200 are urged toward the abutment position and the second fall prevention member 300 holds the gates 200 at the abutment position in an urged state until the gates 200 pass through a connection portion between the first section portion 350a and the second section portion 350b.

According to such a configuration, power consumption for the holding of the gates 200 is suppressed in comparison with a configuration in which the gates 200 are held at the abutment position by means of electric power.

In the transportation device according to the present exemplary embodiment, the gates 200 are urged to the abutment position by the weight 320 provided on a side opposite to the shaft 222, and the second fall prevention member 300 includes the guide mechanism 340 that extends in the transportation direction, that guides the weight 320, and that causes the gates 200 to switch to the withdrawal position with the weight 320 displaced after the gates 200 pass through the connection portion between the first section portion 350a and the second section portion 350b.

According to such a configuration, the gates 200 easily withdraw to the withdrawal position in comparison with a configuration in which the gates 200 are only held at the abutment position in the urged state until the gates 200 pass through the connection portion between the first section portion 350a and the second section portion 350b.

In the transportation device according to the present exemplary embodiment, the guide mechanism 340 includes the first guide 350 that guides the weight 320 in a case where the weight 320 moves in the forward movement direction, the second guide 360 that guides the weight 320 in a case where the weight 320 moves in the backward movement direction, and the switch 370 that is disposed between the first guide 350 and the second guide 360 and that switches between the first guide 350 and the second guide 360 on which the weight 320 moves.

According to such a configuration, a switch to the withdrawal position is easy in comparison with a configuration in which only the first guide 350 and the second guide 360 are provided.

### Third Exemplary Embodiment

Next, a third exemplary embodiment will be described. In the third exemplary embodiment, the configuration of the correction mechanism 100 is different with respect to the major part of the first exemplary embodiment.

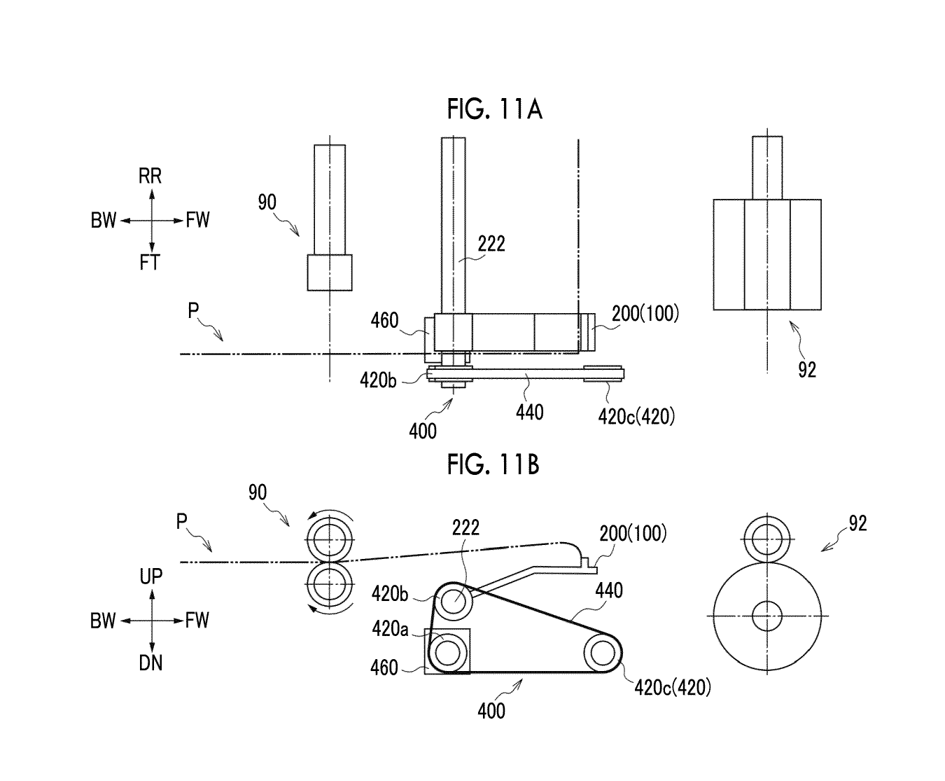

In the third exemplary embodiment, as shown in FIGS. 11A and 11B, the correction mechanism 100 includes an adjustment mechanism 400 that adjusts tension on a belt 440 wound around the shaft 222. The adjustment mechanism 400 adjusts the tension to restrict the rotation of the gates 200. The adjustment mechanism 400 is an example of a restricting member. The adjustment mechanism 400 includes pulleys 420, the belt 440, a motor 460, and an applying unit 480.

The pulleys 420 are formed in a disk-like shape and a plurality of the pulleys 420 are provided. The pulleys 420 are disposed at positions at which the pulleys 420 do not come into contact with the recording medium P on the transportation path 82. In the present exemplary embodiment, the pulleys 420 are disposed ahead of the gates 200 in a plan view. The pulleys 420 include a first pulley 420a, a second pulley 420b, and a third pulley 420c.

The first pulley 420a is rotatably supported by the motor 460 which will be described later.

The second pulley 420b is disposed above the first pulley 420a and is supported by the shaft 222. The second pulley 420b is rotatable together with the shaft 222. In addition, the second pulley 420b reciprocates in the transportation direction as the shaft 222 reciprocates in the transportation direction.

The third pulley 420c is supported to be rotatable with respect to the housing 10a. The third pulley 420c is an example of a pulley portion. The third pulley 420c is disposed downstream of the first pulley 420a in the transportation direction. The position of the third pulley 420c with respect to the housing 10a is displaced as the shaft 222 reciprocates in the transportation direction.

The belt 440 is an endless timing belt wound around the first pulley 420a, the second pulley 420b, and the third pulley 420c. The belt 440 transmits rotation around the central axis of the shaft 222 to the gates 200. The belt 440 is an example of a transmission portion.

The motor 460 is a drive source of which a rotation shaft is supported by the housing 10a in a state of extending along an axial direction of the shaft 222. The motor 460 outputs restriction of rotation of the shaft 222 via the pulleys 420 and the belt 440 in accordance with an instruction from the controller 70. The motor 460 is an example of an output unit. The motor 460 is switchable between an excitation state and a demagnetization state. The motor 460 switches to the excitation state in accordance with an instruction from the controller 70 in a case where a leading end of the recording medium P rotates the gates 200 to the withdrawal position side at the abutment position. In addition, the motor 460 switches to the demagnetization state in accordance with an instruction of the controller 70 at the withdrawal position.

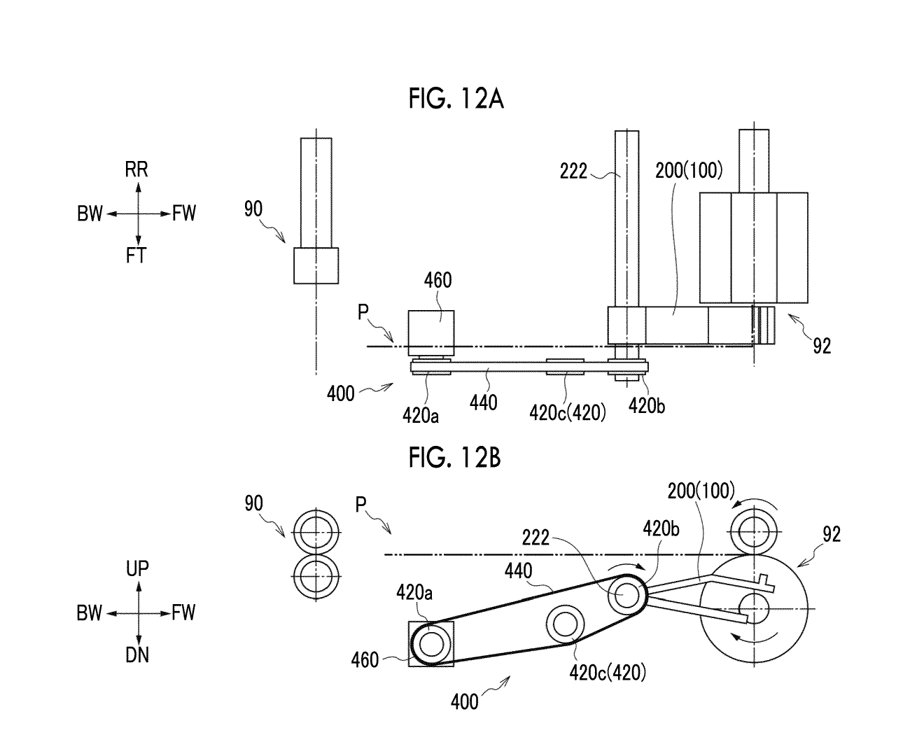

The applying unit 480 (not shown) is a spring member that applies tension to the belt 440 via the pulleys 420. Specifically, the applying unit 480 applies, with respect to the third pulley 420c, the tension in such a direction that looseness of the belt 440, which is caused in a case where the shaft 222 moves in the transportation direction, is restricted. For example, in a case where the gates 200 are positioned at the abutment position, the applying unit 480 applies first tension to the belt 440. In addition, for example, in a case where the gates 200 are positioned at the withdrawal position as shown in FIGS. 12A and 12B, the applying unit 480 applies, to the belt 440, second tension lower than the first tension.

As described above, the adjustment mechanism 400 is configured.

### Action and Effect of Third Exemplary Embodiment

The action and effect of the third exemplary embodiment will be described.

In the transportation device according to the present exemplary embodiment, the adjustment mechanism 400 includes the belt 440 that transmits rotation around the central axis of the shaft 222 to the gates 200 and the motor 460 that is supported by the housing 10a and that outputs, with respect to the belt 440, restriction of rotation around the central axis of the shaft 222.

According to such a configuration, power consumption is suppressed in comparison with a configuration in which the gates 200 are rotated in a direction opposite to the rotation around the central axis of the shaft 222.

In addition, in the transportation device according to the present exemplary embodiment, the belt 440 is an endless belt wound around the motor 460 and the gates 200 and the adjustment mechanism 400 includes the first pulley 420a, the second pulley 420b, and the third pulley 420c that are supported to be rotatable with respect to the housing 10a and around which the belt 440 is wound and the applying unit 480 that applies tension to the belt 440 via the first pulley 420a, the second pulley 420b, and the third pulley 420c.

According to such a configuration, the belt 440 may be prevented from being loosened due to reciprocating movement of the carriage 120 of the correction mechanism 100 in comparison with a configuration in which the belt 440 is wound around only the motor 460 and the gates 200.

### Modification Examples

Hereinabove, a plurality of exemplary embodiments of the present disclosure have been described with reference to the drawings. However, the present disclosure is not limited to the exemplary embodiments and it is clear to those skilled in the art that various other exemplary embodiments of the present disclosure can be adopted within the scope of the present disclosure.

Note that reference numerals and description may be omitted regarding configurations and functions common to the above-described exemplary embodiments and modification examples as follows.

In the first exemplary embodiment, the gates 200 are provided with the first member 250 via the shaft 222. However, the present disclosure is not limited thereto. For example, the first member 250 may be integrally formed with the gates 200.

In the second exemplary embodiment, both the first guide 350 and the second guide 360 are plate-shaped bodies. However, the present disclosure is not limited thereto. For example, the first guide 350 and the second guide 360 may be block-shaped or rod-shaped.

In the second exemplary embodiment, the weight 320 is formed in a columnar shape extending along the shaft 222. However, the present disclosure is not limited thereto. For example, the weight 320 may be formed in a spherical shape, a rectangular shape, or another polygonal shape. In a case where the weight 320 is spherical, frictional resistance caused by reciprocating movement can be reduced in comparison with a weight formed in a columnar shape.

In the third exemplary embodiment, the transmission portion is the belt 440. However, the present disclosure is not limited thereto. For example, the transmission portion may be a chain. In this case, for example, it is preferable that a sprocket is used as the pulley portion.

An example of the image forming apparatus 10 is not limited to the above-described electrophotographic image forming apparatus 10, and for example, various image forming apparatuses including an ink jet image forming apparatus can be used. In an ink jet type image forming apparatus, for example, ink droplets are jetted to a recording medium from a jetting unit (not shown) so that an image is formed on the recording medium.

In the above-described exemplary embodiments, the abutting member is urged toward the abutment position or the withdrawal position and the restricting member holds the abutting member at the abutment position until the abutting member passes through the first position. However, the present disclosure is not limited thereto. For example, the abutting member may not be urged to any of the abutment position and the withdrawal position.

In the above-described exemplary embodiments, the holding target portion is formed in a plate-like shape extending in the transportation direction. However, the present disclosure is not limited thereto. For example, the holding target portion may be formed in a rod-like shape or a block-like shape extending in the transportation direction.

In the above-described exemplary embodiment, the abutting member is urged to the abutment position by the weight provided on a side opposite to the axis. However, the present disclosure is not limited thereto. For example, a member having a function other than a function as the weight may also be used as the weight.

In the above-described exemplary embodiments, the guide portion includes the forward path portion toward the downstream side, the backward path portion toward the upstream side in the transportation direction, and the switching unit that is disposed between the forward path portion and the backward path portion and that switches the position of the guide portion. However, the present disclosure is not limited thereto. For example, the switching unit may be integrally formed with the forward path portion or the backward path portion.

In the above-described exemplary embodiments, the restricting member includes the transmission portion that transmits rotation around the axis to the abutting member and the output unit that is supported by the apparatus body and that outputs, with respect to the transmission portion, restriction of the rotation around the axis. However, the present disclosure is not limited thereto. For example, the output unit may be disposed to be coaxial with the transmission portion.

In the above-described exemplary embodiment, the transmission portion is an endless belt wound around the output unit and the abutting member. However, the present disclosure is not limited thereto. For example, the transmission portion may be a chain.

### Supplementary Notes

### (((1)))

A transportation device comprising:
a transportation member that transports a medium in a transportation direction;
a reciprocating mechanism that reciprocates in the transportation direction and that moves at a speed lower than a transportation speed of the medium transported by the transportation member in a case where the reciprocating mechanism moves to a downstream side;
an abutting member that is supported by the reciprocating mechanism and that is switchable between an abutment position at which the medium abuts against the abutting member on a transportation path of the medium and a withdrawal position to which the abutting member withdraws from the transportation path by rotating around an axis after the abutting member passes through a predetermined first position; and
a restricting member that restricts the abutting member from rotating to a withdrawal position side until the abutting member passes through the first position.

### (((2)))

The transportation device according to (((1))),
wherein the abutting member is urged toward the abutment position or the withdrawal position, and
the restricting member holds the abutting member at the abutment position until the abutting member passes through the first position.

### (((3)))

The transportation device according to (((2))),
wherein the abutting member is urged toward the withdrawal position, and the restricting member includes
   a supporting portion that extends in the transportation direction and that is supported by an apparatus body, and
   a holding target portion that is provided at the abutting member and that is in contact with the supporting portion so that the abutting member is held at the abutment position until the abutting member passes through the first position.

### (((4)))

The transportation device according to (((3))),
wherein the holding target portion is formed in a plate-like shape extending in the transportation direction.

### (((5)))

The transportation device according to (((2))),
wherein the abutting member is urged toward the abutment position, and
the restricting member holds the abutting member at the abutment position in an urged state until the abutting member passes through the first position.

### (((6)))

The transportation device according to (((5))),
wherein the abutting member is urged to the abutment position by a weight provided on a side opposite to the axis, and
restricting member includes a guide portion that extends in the transportation direction, that guides the weight, and that causes the abutting member to switch to the withdrawal position with the weight displaced after the abutting member passes through the first position.

### (((7)))

The transportation device according to (((6))),
wherein the guide portion includes
   a forward path portion that guides the weight in a case where the weight moves to the downstream side,
   a backward path portion that guides the weight in a case where the weight moves to an upstream side in the transportation direction, and
   a switching unit that is disposed between the forward path portion and the backward path portion and that switches a position of the guide portion.

### (((8)))

The transportation device according to (((1))),
wherein the restricting member includes
   a transmission portion that transmits rotation around the axis to the abutting member, and
   an output unit that is supported by an apparatus body and that outputs, with respect to the transmission portion, restriction of the rotation around the axis.

### (((9)))

The transportation device according to (((8))),
wherein the transmission portion is an endless belt wound around the output unit and the abutting member, and
   the restricting member includes
      a pulley portion that is supported to be rotatable with respect to the apparatus body and around which the belt is wound, and
      an applying unit that applies tension to the belt via the pulley portion.

### (((10)))

An image forming apparatus comprising:
the transportation device according to any one of (((1))) to (((9))); and
a forming unit that forms an image on the medium transported by the transportation device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transportation device comprising:
a transportation member that transports a medium in a transportation direction;
a reciprocating mechanism that reciprocates in the transportation direction and that moves at a speed lower than a transportation speed of the medium transported by the transportation member in a case where the reciprocating mechanism moves to a downstream side;
an abutting member that is supported by the reciprocating mechanism and that is switchable between an abutment position at which the medium abuts against the abutting member on a transportation path of the medium and a withdrawal position to which the abutting member withdraws from the transportation path by rotating around an axis after the abutting member passes through a predetermined first position; and
a restricting member that restricts the abutting member from rotating to a withdrawal position side until the abutting member passes through the first position.

2. The transportation device according to claim 1,
wherein the abutting member is urged toward the abutment position or the withdrawal position, and
the restricting member holds the abutting member at the abutment position until the abutting member passes through the first position.

3. The transportation device according to claim 2,
wherein the abutting member is urged toward the withdrawal position, and
the restricting member includes
a supporting portion that extends in the transportation direction and that is supported by an apparatus body, and
a holding target portion that is provided at the abutting member and that is in contact with the supporting portion so that the abutting member is held at the abutment position until the abutting member passes through the first position.

4. The transportation device according to claim 3,
wherein the holding target portion is formed in a plate-like shape extending in the transportation direction.

5. The transportation device according to claim 2,
wherein the abutting member is urged toward the abutment position, and
the restricting member holds the abutting member at the abutment position in an urged state until the abutting member passes through the first position.

6. The transportation device according to claim 5,
wherein the abutting member is urged to the abutment position by a weight provided on a side opposite to the axis, and
the restricting member includes a guide portion that extends in the transportation direction, that guides the weight, and that causes the abutting member to switch to the withdrawal position with the weight displaced after the abutting member passes through the first position.

7. The transportation device according to claim 6,
wherein the guide portion includes
a forward path portion that guides the weight in a case where the weight moves to the downstream side,
a backward path portion that guides the weight in a case where the weight moves to an upstream side in the transportation direction, and
a switching unit that is disposed between the forward path portion and the backward path portion and that switches a position of the guide portion.

8. The transportation device according to claim 1,
wherein the restricting member includes
a transmission portion that transmits rotation around the axis to the abutting member, and
an output unit that is supported by an apparatus body and that outputs, with respect to the transmission portion, restriction of the rotation around the axis.

9. The transportation device according to claim 8,
wherein the transmission portion is an endless belt wound around the output unit and the abutting member, and
the restricting member includes
a pulley portion that is supported to be rotatable with respect to the apparatus body and around which the belt is wound, and
an applying unit that applies tension to the belt via the pulley portion.

10. An image forming apparatus comprising:
the transportation device according to claim 1; and
a forming unit that forms an image on the medium transported by the transportation device.

11. An image forming apparatus comprising:
the transportation device according to claim 2; and
a forming unit that forms an image on the medium transported by the transportation device.

12. An image forming apparatus comprising:
the transportation device according to claim 3; and
a forming unit that forms an image on the medium transported by the transportation device.

13. An image forming apparatus comprising:
the transportation device according to claim 4; and
a forming unit that forms an image on the medium transported by the transportation device.

14. An image forming apparatus comprising:
the transportation device according to claim 5; and
a forming unit that forms an image on the medium transported by the transportation device.

15. An image forming apparatus comprising:
the transportation device according to claim 6; and
a forming unit that forms an image on the medium transported by the transportation device.

16. An image forming apparatus comprising:
the transportation device according to claim 7; and
a forming unit that forms an image on the medium transported by the transportation device.

17. An image forming apparatus comprising:
the transportation device according to claim 8; and
a forming unit that forms an image on the medium transported by the transportation device.

18. An image forming apparatus comprising:
the transportation device according to claim 9; and
a forming unit that forms an image on the medium transported by the transportation device.
